(19) United States
(12) Patent Application Publication
(10) Pub. No.: US 2017/0287002 A1
(43) Pub. Date: Oct. 5, 2017

(54) TARGETING CONTENT FOR USERS OF EXTERNAL WEBSITES

(71) Applicant: Ten-X, LLC, Irvine, CA (US)

(72) Inventor: Kamran Bakhtiari, Irvine, CA (US)

(21) Appl. No.: 15/143,268

(22) Filed: Apr. 29, 2016

Related U.S. Application Data
(60) Provisional application No. 62/318,209, filed on Apr. 4, 2016.

(51) Int. Cl. G06Q 30/02; G06Q 50/16; H04L 29/08

(52) U.S. Cl. CPC G06Q 30/0255; H04L 67/22; H04L 67/146; G06Q 30/0277; G06Q 50/16

(57) ABSTRACT

A content providing entity controls use of a cookie that is placed on individual computers that download a resource from a publisher site, hosted at publisher domain. The individual computers can be programmatically triggered to directly transmit cookie data, collected through placement of the cookie on the respective computer, to a network location that resides with a domain of the content providing entity. The content providing entity can select, using the cookie data, a subset group of the visitors to receive content items selected from an inventory database of the content providing entity. The content providing entity transmits the selected content items to the computers of the subset group using the cookie stored with each of the visitor computers.

### CROSS-REFERENCE TO RELATED APPLICATIONS

This application claims the benefit of priority to U.S. Provisional Patent Application No. 62/318,209, filed Apr. 4, 2016. The aforementioned priority application is hereby incorporated by reference in its respective entirety.

### TECHNICAL FIELD

Examples described herein pertain generally to targeting content over a network.

### BACKGROUND

Ad network services provide forms of persistent or universal cookies, which track individuals for purpose of collecting profile information. Advertisers can also use cookies on sites they host, but usually cookies do not track user activity outside of the site.

### BRIEF DESCRIPTION OF THE DRAWINGS

FIG. 1 illustrates a system for targeting content to visitors of external websites, according to some examples.

FIG. 2 illustrates an example of logic for controlling use of cookie data from external websites.

FIG. 3 illustrates an example method for targeting content to visitors of external websites, according to some examples.

FIG. 4A through FIG. 4D illustrate example interfaces for implementing one or more embodiments.

FIG. 5 illustrates an example computer system for use with some examples, as described.

### DETAILED DESCRIPTION

According to some examples, a content providing system (or entity) can provide targeted content using cookie data obtained from an external site. In one implementation, a content providing system can control use of a cookie that is placed on individual computers that download a resource from a publisher site, hosted at a publisher domain. The individual computers can be programmatically triggered to directly transmit cookie data—collected through placement of the cookie on the respective computer—to a network location that resides within a domain of the content providing system. The content providing system can select, using the cookie data, a subset group of the visitors to receive content items selected from an inventory database of the content providing system. The content providing system can also transmit the selected content items to the computers of the subset group using the cookie stored with each of the visitor computers.

In some examples, the cookie data is transmitted from the publisher site to a network location for the content providing system when the visitor computer renders, from the publisher site, content that is associated with a transaction listing that is active on a website of the content providing system. In some variations, the cookie data is transmitted from the publisher site to the network location of the content providing system when the visitor renders, from the publisher site, content associated with an asset that is the subject of an active listing at a website of the content providing system. Examples described herein provide for a network system to deliver targeted content to visitors of external websites. In particular, examples describe a network system that controls the use of cookie data, located on computer systems of visitors to external websites, in order to select a campaign.

As used herein, an “real-property asset” can refer to different types of real estate property, such as a single family residence, a condominium, an apartment, a commercial property, a parcel of land, or a note (e.g., mortgage). As used herein, “external websites” can refer to web pages or hyperlinks that point to web pages that are prepared, maintained and associated with an entity, group or organization that is independent of or different from the content providing system.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers, desktop computers, cellular or smartphones, personal digital assistants (e.g., PDAs), laptop computers, printers, digital picture frames, network equipment (e.g., routers) and tablet devices. Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples of the invention can be carried and/or executed. In particular, the numerous machines shown with examples of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

System Description

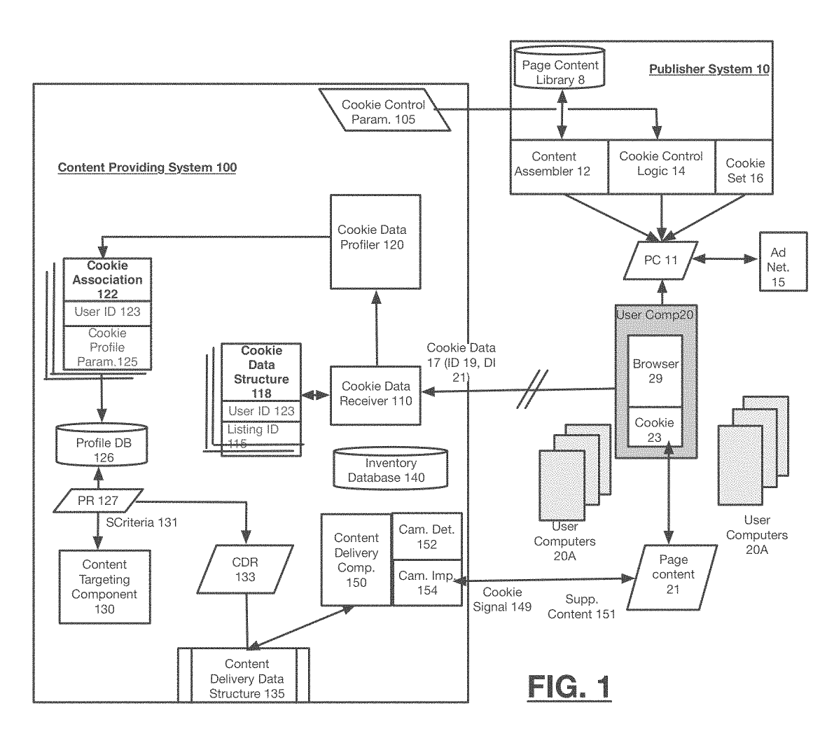

FIG. 1 illustrates a system for targeting content to visitors of external websites, according to some examples. A system 100 such as described by an example of FIG. 1 can be implemented in a variety of computing environments. In some examples, system 100 can be implemented as part of an online market place, in which an inventory of available items for sale or transactions is maintained and made available for transaction to users who access a website hosted by system 100. Accordingly, system 100 can be implemented as a network service, through a combination of servers and/or other network enabled computing devices.

With reference to FIG. 1, the content providing system 100 includes a cookie data receiver 110, a cookie data profiler 120 and a content targeting component 130. According to examples, the system 100 hosts one or more websites which host transaction listings by which transfers and conveyances may occur for goods, services, assets or other rights. Each transaction listing can be active or inactive. Inactive transaction listings can identify prior transactions which have expired, or future transactions which have not yet been made available for action to prospective users (e.g., buyers). Conversely, an active transactional listing is one that a user can act upon as a purchaser, bidder or prospective purchaser/bidder. An inventory database 140 can store the transaction listings, including the content items associated with each transaction listing. The transaction listings can be provided by the system 100 and can each include an associated content item, which can include text and images, as well as other information about the goods, service, asset or right that is the subject of the transaction. For active transaction listings, the content can be dynamic to reflect changing information such as (i) time left by which the transaction listing will remain active, (ii) number of viewers of the transaction listing, (iii) number of users who have registered as prospective purchasers for the transaction listing, (iv) bids or offers, whether submitted in an auction format or for consideration by a seller, and/or (v) content provided by one party of the transaction (e.g., seller), including chats, documentation (e.g., seller verification information, appraisals, etc.).

As described with various examples, the content items can be rendered through the website hosted by the system 100 or the publisher system 10. By way of example, a transactional listing can pertain to assets, such as non-fungible assets (e.g., real-estate assets), as well as goods or services (e.g., sale of fungible items, such as used consumer electronics or bulk sale of specific item). When the transactional listing is active, the user can take steps towards acquiring the asset that is offered through the transactional listing. The content items of the active transaction listings can include features which enable the user to make a submission of a bid, offer, or inquiry and/or perform other actions such as link to another resource (e.g., primary web page) where the transaction listing is provided.

According to some examples, the system 100 can operate in connection with at least one publisher system 10, in order to implement, control or otherwise cause logic to be provided with page content distributed on a website hosted by the publisher system 10. The page content 11 can correspond to a downloaded webpage or an application page provided under a framework in which supplemental content can be selected and rendered at the time of download. Under conventional approaches, supplemental content can include ads provided by an ad network 15. Additionally, examples enable supplemental content in the form of selected content items from system 100, which can distribute content based on the inventory database 140. A population of users can operate computers 20A, represented by user computer 20, to access the website hosted by the publisher system 10. A user may operate the user computer 20 to access a website hosted by the publisher system 10, in order to search, navigate or otherwise select content which can be downloaded via a browser 29. According to examples, the user computer 20 can correspond to a consumer-based computer system, such as a desktop or laptop computer which runs a commercially available browser (e.g., MICROSOFT EXPLORER (manufactured by the Microsoft Corporation), CHROME (manufactured by Google, Inc.) or FIREFOX (manufactured by Mozilla)). In variations, the user computer 20 can correspond to the mobile computing device, such as a messaging/telephony device, tablet, wearable device or notebook. In examples, the user computer 20 can store a persistent cookie 23, provided through interaction with a website hosted by either the system 100, or the publisher system 10 and/or another website, which links the visitor computer 20 to the system 100.

In providing the website, the publisher system 10 can include content assembler 12, cookie control logic 14 and cookie setter 16. The content assembler 12 can assemble page content 11 for user computer 20 using content items which are identified in a page content library 8 of the publisher system 10. In some examples, the publisher system 10 hosts a website which displays content and information relating to transactional listings, including active transactional listings which are hosted at the system 100. In some examples, the publisher system 10 publishes page content 11 to include transactional listings that are active and hosted on the system 100. For example, the system 100 can host a website where real estate or other non-fungible assets are made available for one or multiple kinds of transactions, including sales or leases. Still further, the system 100 can host a website where such assets are transacted using either an auction or negotiation forum. In one implementation, the page content library 8 of the publisher system 10 can include transactional listings from sources that are external (e.g., operated independently and on external domains) to the publisher system 10, including transaction listings which are active on the system 100.

The user computer 20 can interact with the page content 11 provided by the publisher system 10 in order to (i) obtain more information about an asset of a displayed transaction, (ii) barter or negotiate on terms of the transaction, (iii) place a bid for the asset, or (iv) accept an offer and complete a transaction identified through the transactional listing. In some examples, the transactional listing can identify, link to or publish an ongoing auction. Still further, examples provide for transactional listings which can encompass or include alternative forms of conveyances, such as sale, lease, or timeshare.

The cookie setter 16 can include functionality that provides a persistent cookie 23 to the user computer 20. The cookie 23 may be exclusively linked to the system 100, such that data stored with the cookie 23 is only accessible to the system 100. In some examples, the cookie 23 can be stored with the user computer 20 when certain conditions are met, such as when the user computer 20 views content that originates from the system 100. The cookie 23 can be persistent, meaning it is stored on the user computer 20 across multiple online sessions conducted through the publisher system 10.

According to some examples, the publisher system 10 includes cookie control logic 14 to control the use of the cookie 23 on the user computer 20. The cookie control logic 14 can be implemented as script logic, which executes on the page content 11, in order to generate and transmit cookie data 17 to the system 100. The cookie data 17 can include an identifier (ID) 19 for the user or computer, and one or more data items (DI) 21 that identify a transactional listing rendered for the user computer 20. In examples in which the transactional listing is provided by the system 100, the data items 21 can include separate identifiers that identify transaction listings (or assets thereof) hosted by the system 100 (e.g., numeric identifier specific to a transaction that is active on the system 100). In some examples, the ID 19 is anonymized and/or specific to the user computer 20. In variations, however, the transaction listings may be of a nature in which a user of the user computer 20 registers or logs in to the publisher system 10. In such cases, the ID 19 can identify the user or user account on the publisher system 10. Still further, the cookie control logic 14 can include functionality for parsing and/or evaluating content that is rendered to the user computer 20. In such examples, the cookie data 17 can carry data items 21 such as categorical identifiers, semantic descriptors or other information that is indicative of a type, category or facet of a transactional listing, or asset of the transactional listing.

According to some examples, the cookie data 17 is communicated directly to the system 100. For example, the cookie data 17 can be stored in the memory of the user computer 20, where the data is retrieved by the cookie data receiver 110. When communicated directly, the cookie data 17 is not accessible to the publisher system 10, or any third-party. In some variations, the cookie control logic 14 implements controls to preclude data items 21 from being stored as part of the cookie 23 when the page content 11 renders transactional items that do not originate, or reference active transactions provided on a website hosted by or associated with the system 100.

The cookie data receiver 110 receives the cookie data 17 and stores the cookie data 17 as cookie data structure 118. In some implementations, the cookie data structure 118 can include one or more local user identifiers 123 for the user computer 20, as well as one or more listing identifiers 115 for transactional listings stored in the inventory database 140 of transaction listings provided by the system 100. The local user identifier 123 corresponds to or is a copy of the identifier 19 of the cookie data 17. Alternatively, the system 100 can translate or map the identifier 19 provided by the publisher site to the local user identifier 123 that may be listed with a user account of the system 100. In other variations, the local user identifier 123 is temporary, but identifiable across one or more sessions to link multiple activities of the user to a single record. Accordingly, the local user identifier 123 can be anonymized, such that it is not linked to personal identifiable information. Alternatively, the local user identifier 123 can be specific to an individual or actual account hosted at the system 100.

The cookie profiler 120 can process the cookies data structures 118 to determine cookie data profile parameters 125 for individual user computers 20. The cookie profiler 120 can determine the cookie data profile parameters 125 using any one of a variety of techniques. In some examples, the cookie data profile parameters 125 include parameters that identify or quantify salient characteristics of interest for transaction listings in general, or for transaction listings that are active and hosted at the system 100. The profile parameters can include, for example, geographic parameters that are specific to a particular geographic region that is of interest to the corresponding user, such as a state, city, or neighborhood. Still further, the cookie profiler 120 can determine one or more profile parameters that include a price range for transactions that are associated with the system 100.

In more specific examples for transactions relating to real-property assets, the set of parameters can include, for example, a property type, a size of the dwelling, a lot size, a number of bedrooms, a number of bathrooms, and/or presence of other features (e.g., connected garage, remodeled, swimming pool, presence of homeowner association and fees, etc.). Other examples of characteristics for the real-property asset type can include a geography where the asset is located (e.g., state and county or city), a neighborhood (e.g., school district or the named development) of the asset, and/or other predefined metrics (e.g., proximity to a desirable location, presence or type of public transit, etc.).

The cookie association data structure 122 may represent an association between the cookie identifier 19, the corresponding local user identifier 123 and one or more profile parameters 125. As an addition or alternative, the cookie association data structure 122 can also store information that identifies the transaction listing or listings which were viewed by the user at the publisher's website. The cookie association data structure 122 can be stored in a profile database 126. In some examples, the cookie profile database 126 can be stored in a manner that maintains historical information specific to the local user identifier 123. In variations, the cookie association data structure 122 can be stored in the profile database 126 as session based data. Still further, in other variations, the cookie association data structure 122 can represent an aggregation of multiple cookie profile parameters 125 determined from prior sessions of a computer or user associated with the local user identifier 123.

As an addition or variation, a history of transaction listings of interest to the user or computer associated with the local user identifier 123 can be stored and maintained. In such instances, the transaction listings can be received through cookie data 17 from the publisher system 10, and/or from the user's activity at a website hosted by the system 100 and/or at another website of another publisher. For a local account associated with the user computer 20, the profile database 126 can store cookie profile parameters 125 and/or other information determined from user activity with respect to the website of the publisher system 10, the system 100, and/or other third-party websites. By way of example, the user activity can include (i) the browser 29 of the user computer 20 rendering a page that pertains or shows a transaction listing hosted by the system 100, (ii) the user entering a search term, or receiving a search result that shows or otherwise identifies a transaction listing hosted by the system 100, and/or (iii) the user being shown supplemental content corresponding to the transaction listing of the system 100 and then selecting to view the supplemental content as primary content. In this way, the cookie 21 can be used by the system 100 to determine the cookie profile parameters 125, as well as historical information about transaction listings that are of interest to the particular user. As described in greater detail, the system 100 can target supplemental content to the browser 23 of the user computer 20 based on the cookie profile parameters 125 and/or information determined from user activity at websites hosted by the publisher system 10, the system 100, or third-parties.

According to some examples, the content targeting component 130 accesses the profile database 126 in order to determine selection criteria 131 for selecting content items for display on computers that are associated with each local user identifier 123. The selection criteria 131 can be linked or associated with a profile record 127 for the local user identifier 123 in the profile database 126. In some examples, the selection criteria 131 is structured as a link (e.g., HTML link) to a content item stored in the inventory database 140 of the system 100.

Each profile record 127 can also include a content delivery record (CDR) 133 that is linked to the cookie identifier 19 that is associated with the account identified by local user identifier 123. The content delivery record 133 can be stored in an alternative content delivery data structure 135 of the system 100. In some examples, the content delivery data structure 135 can be implemented in a fast memory resource, such as provided by, for example, cache or DRAM.

In some implementations, the content delivery record 133 can include selection criteria 131 for each cookie identifier 19 (not shown for simplicity). In variations, the content delivery record 133 can store identifiers to content items hosted on the content delivery system 100. Still further, the content delivery data structure 135 can be provided with logic or functionality that uses selection criteria 131 to maintain identifiers to content items which are active. In this way, the content delivery record 133 maintains selection criteria 131 (e.g., links to specific transaction listings of the system 100) that is up to date or current (not shown for simplicity).

A content delivery component 150 of the system 100 can operate to transmit supplemental content 151 to the browser 29 when the user navigates to select websites hosted by third-parties. The content delivery component 150 may receive a cookie input signal 149, corresponding to an impression or rendering of a web page or content at a monitored website. The monitored website can be hosted by, for example, the system 100, the publisher system 10 or a third party site. The content delivery component 150 can retrieve, or otherwise determine the cookie identifier 19 from the cookie data 17 associated with the computer which downloaded page content from the monitored website. The cookie identifier 19 can be referenced against the content delivery data structure 135 of the system 100 in order to determine the content delivery record 133 that is associated with the identifier 19. The selection criteria 131 of the content delivery record 133 can be used to determine the content items from the transaction listing database 140 of the system 100.

The content delivery component 150 can include a campaign determination component 152 and a campaign implementation component 154. The campaign determination component 152 can, for example, filter the content delivery data structure 135 in order to determine the set of user computer 20 which are part of one or more of the individual campaigns. The campaign determination component 152 can, for example, select whether a particular computer (or user) associated with a cookie identifier 19 is suitable for a particular campaign. The campaign implementation component 154 can also enable content items of the system 100 to be targeted to select computers of the user population on which the cookie 23 is stored, in accordance with a predetermined criteria or objective. The content delivery network 150 can receive the input signal 149, determine whether the cookie identifier of the input signal 149 is associated with one of the campaigns, and select content items from the inventory database 140 of the system 100.

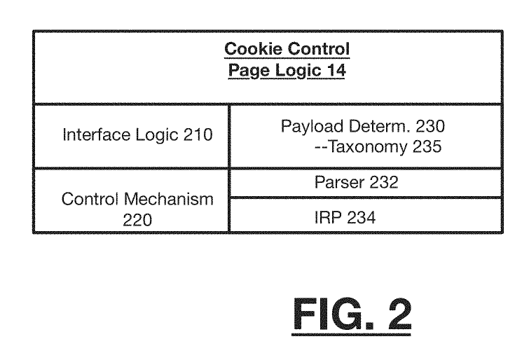

FIG. 2 illustrates an example of cookie control logic implemented on a publisher site, according to one or more examples. The cookie control logic 14 can be implemented as script logic which executes as part of the page content 11 when the user computer 20 downloads a web page from the publisher system 10. The cookie control logic 14 can functionally be described in terms of (i) an interface logic 210 that executes to establish a direct connection with the system 100; (ii) a control mechanism 220, including logic and/or settings, which controls access to the cookie data 17 of the cookie 23; and (iii) a payload determination mechanism 230, which identifies the constituent data items of the cookie data 17.

In one implementation, the user downloads the page content 11, triggering the cookie control logic 14 to execute as a script. During execution, the cookie control logic 14 can initiate the interface logic 210 to signal a communication to the content delivery component 150 of the system 100. For example, the interface logic can trigger the browser 29 to make a call (e.g., output the cookie input signal 149) to the content delivery component 150. In making the call, the browser 29 can provide some data, such as the browser, user, account, session identifier, and/or machine identifier associated with the user computer 20. The content delivery component 150 can retrieve the cookie data 17 from a data store of the cookie 23.

The payload determination mechanism 230 can refer to functionality implemented with, for example, the script executing on the page content 11 to identify and store data items 21 of the cookie 23. The payload determination mechanism 230 can be embedded with the page content 11, or retrieved in whole or in part once the page content 11 is completely loaded. Still further, the payload determination mechanism 230 can be retrieved and/or executed once the browser identifies whether a cookie is set on the user computer 20 for the system 100. The payload determination mechanism 230 can provide any one of multiple types of functionality for determining the data items 21 of the cookie 23. The page content 11 may be seeded so that the payload determination mechanism 230 is extensible, with functionality selected or retrieved (e.g., from a source of the system 100) on demand.

According to some examples, the payload determination mechanism 230 includes at least one of an asset identifier or transaction identifier, which can be referenced in the inventory database 140 to determine an associated transaction listing and/or content item. In variations, the payload determination mechanism 230 includes components which enable the subject content of the page content 11 to be categorized in a manner that is meaningful, with respect to the inventory database 140. In some examples, the payload determination mechanism 230 can include a text parser 232 and/or image recognition process 234 to determine attributes of the subject for the page content 11. For example, in the case of real-estate assets, the text parser 232 can be trained to identify certain keywords, such as “bedrooms” “lot size” or “sq. ft.” (or variants thereof). Likewise, the image recognition process 234 can be trained to recognize text from the images in similar fashion. A taxonomy 235, such as a structured data set, can be used to define the semantic space which text parser 232 or image recognition process 234 may be trained to determine, wherein the semantic space can be based on the type of subject being viewed by the page content 11. For non-fungible assets other than real-estate, such as art work, for example, the taxonomy can identify “artist” “original” “print edition” etc.

The control mechanism 220 can cause the determinations made from the payload determination mechanism 230 to be stored on the user computer 20, as part of the payload (e.g., data items 21) for the cookie 23. The control mechanism 220 can further preclude access to the cookie data 17 from any source other than the system 100. The control mechanism 220 can, for example, implement a control so that the cookie data 17 is only retrievable from a given domain or network location associated with the system 100. In some examples, the cookie 23 may be set by the publisher system 10, so that the control mechanism 220 precludes the setting entity from accessing the cookie data 17. By way of example, the control mechanism 220 can utilize a key that enables the cookie data 17 to be accessible when the requesting source has the matching key.

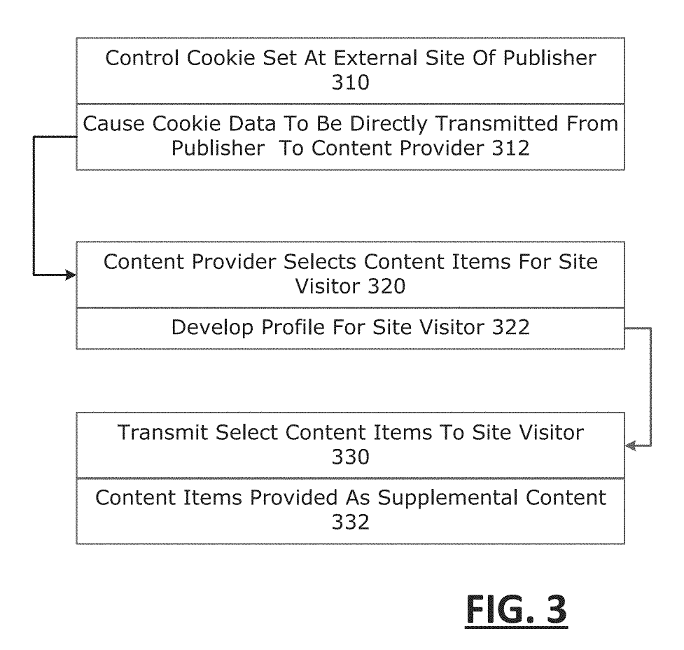

With reference to an example of FIG. 3, a cookie on user computer 20 can be set by the publisher system 10 on a given computer of a site visitor, while the use of the cookie may be under control of the system 100 (310). As described with various examples, the publisher system 10 may operate a site that is external to the system 100. In other words, the system 100 and publisher system 10 can be operated under different domains, and by different controlling entities. In numerous examples, the publisher system 10 and the system 100 can each host a website relating to real-estate listings (e.g., by sale or lease). In some examples, the system 100 may provide listings which are actionable to complete or further the transaction, while the publisher system 10 may publish content that requires another party to conduct or host the actual transaction.

In one implementation, the publisher system 10 sets the cookie 23 on the user computer 20 in response to certain conditions or events, such as the user being randomly selected, or the user electing to view a content item originating from the inventory database 140 of the system 100. When the cookie is set, the user may subsequently or concurrently view the page content 11, causing activation and use of the cookie. The cookie control logic 14 of the publisher system 10 may implement a control parameter or mechanism that is defined or specific to the system 100. The script logic, for example, can cause the cookie data 17 determined through placement of the cookie on the individual user computers to be directly transmitted to the network location of the content providing system (312). Thus, the cookie data can be communicated to the system 100 without use of publisher system 10 as an intermediary. Such an arrangement can protect, for example, the proprietary nature of the content item which triggers the cookie data transmission.

Moreover, the system 100 can use the publisher system 10 to expand the reach of its user base without the user actually visiting a website of the system 100. In some variations, for example, the visitor computer 20 can be used to render interactive content items to active transaction listings, but the content items can be rebranded to appear as originating from the publisher system 10. Further interaction by the user of user computer 20 can also be under, for example, a rebrand framework, so that the transaction listing receives interest and activity to promote completion of the transaction, using a customer or customer base that is unfamiliar with, for example, the system 100 or websites which are hosted by the system 100. However, since the customers are not being driven to an alternative site (at least with respect to branding), the publisher system 10 is motivated to set the cookie 23 and/or enable its use, as the system 100 can provide the publisher system 10 with added inventory.

The programmatic elements of the system 100 can select one or more content items for the user computer 20 based on cookie data 17 communicated from use of the cookie 23 (320). The content items can correspond to content for transaction listings hosted at a website of the system 100. In one implementation, the cookie data 17 communicated from the user computer 20 is at a first time instance, when the user is viewing page content 11 a subject item originating from the system 100 (e.g., active transaction listing).

Still further, in some variations, the system 100 selects content items for the user computer 20 by first developing a profile of the user from the cookie data 17 (322). The user profile can be used to develop a campaign for at least some profiles, using content items of active transaction listings hosted at the system 100.

The selected content items can then be transmitted to the user computer 20 (330). In some variations, the selected content items are transmitted as supplemental content, such as in the form of an advertisement (332) or as an entry in a search result or sort. Additionally, in some variations, the selected content items can be transmitted after the user has downloaded page content 11 having a subject that originates from the inventory database 140 of the system 100. Subsequently, the user can navigate and use their browser 29 on other properties of the publisher system 10, or alternatively navigate to one or more third party sites. In either case, the system 100 can determine selection criteria 131, or alternatively pre-select content items 142 based on information determined from the cookie data 17. Thus, in some examples, the selected content items are transmitted to the user computer 20 as supplemental content, once the cookie is set and the user performs some action that is indicative of the user's interest in a subject item.

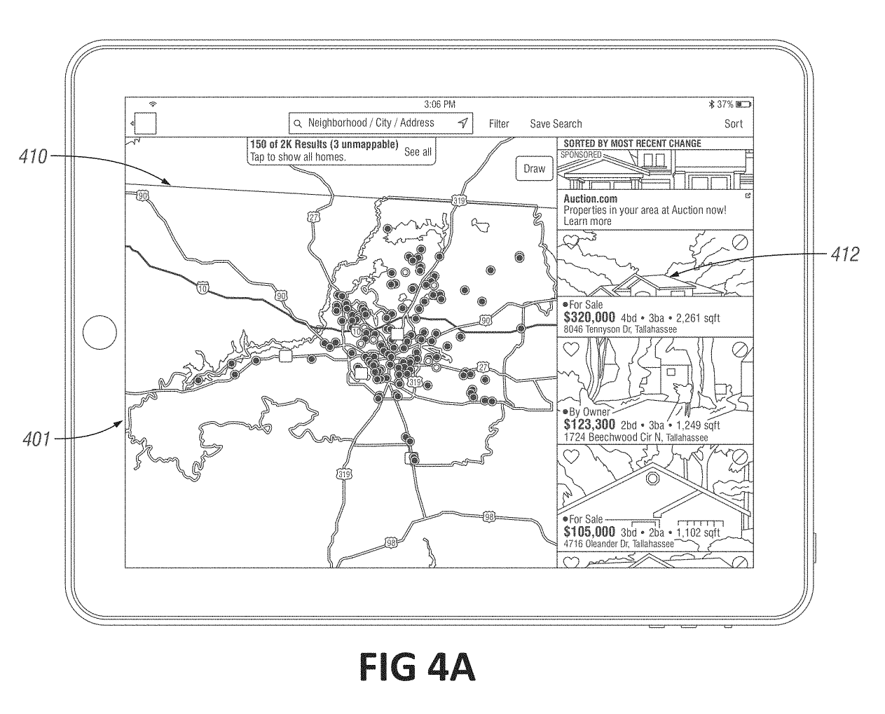

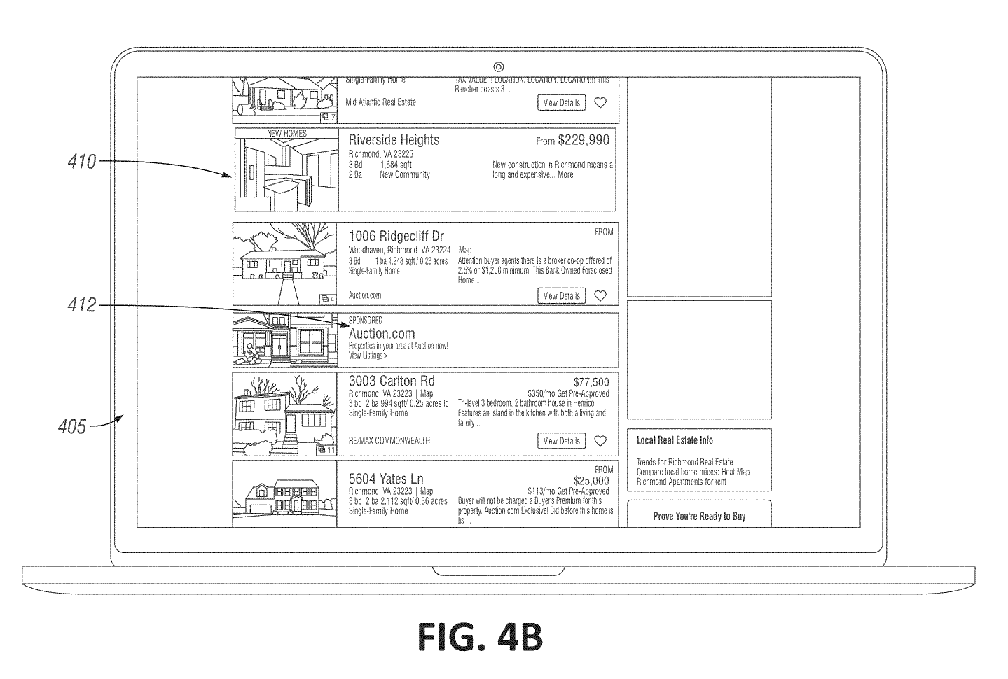

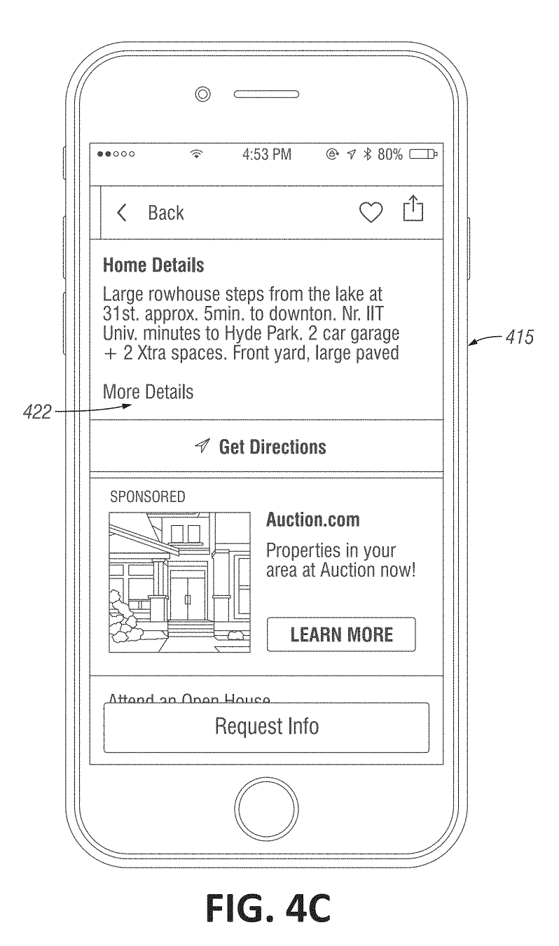

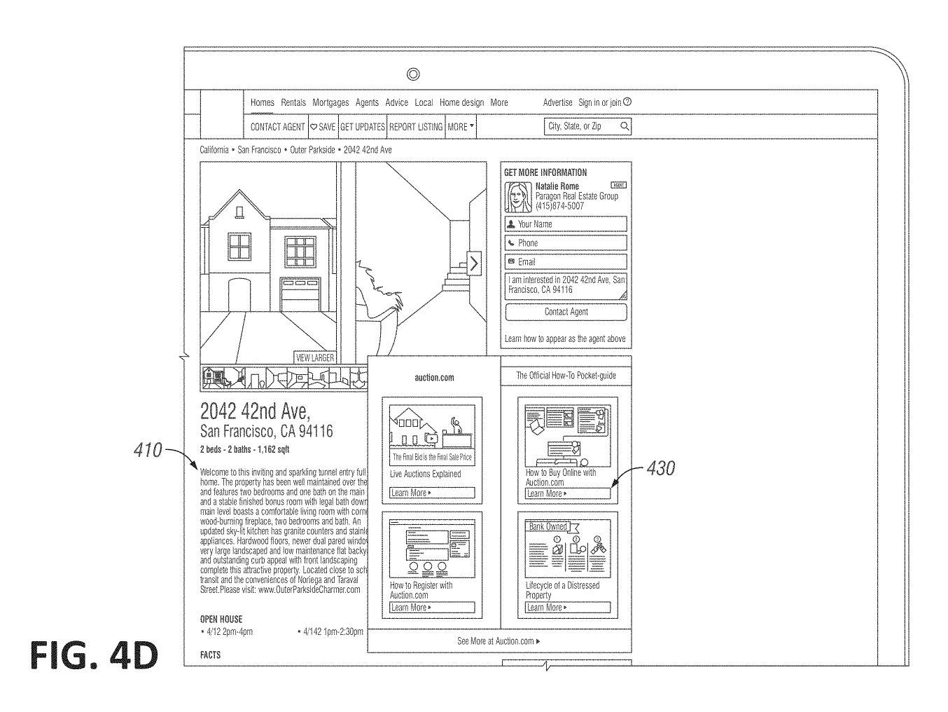

FIG. 4A through FIG. 4D illustrate example interfaces for implementing one or more embodiments. In particular, FIG. 4A through FIG. 4D provide example interfaces for displaying selected content items from the inventory database inventory database 140 of the system 100 as supplemental content when a given user is browsing an independent publisher site.

In FIG. 4A, an interface 410 (e.g., web page for app or browser running on tablet 401) illustrates a geographic interface 412, hosted at the publisher system 10, which enables the user to indicate a geographic region of interest. As described with other examples, the user's computer may store the cookie 23, which enables the system 100, acting as a transaction hosting site, to provide supplemental content in the form of an active transaction listing from the inventory database 140 of the system 100. In the example shown, the cookie data 17 can carry data that includes the input geographic parameter, and the system 100 can optionally use a profile associated with the cookie 23 to determine what type of real-estate listing (e.g., residential, size of lot, size of house by bedroom or bathroom, type of house, type of transaction) to select for the user. A selected real-estate listing 412 can be provided to the user in the form of a search result entry.

FIG. 4B and FIG. 4C illustrate variations in which a selected content item is displayed as part of a search result or other form of supplemental content. In FIG. 4B, the computing environment is a laptop 405 which accesses the publisher system 10 using a browser. The interface 410 from the publisher system 10 provides a search result or sort, and one or more of the entries 412 that corresponds to an active listing hosted at the system 100. In FIG. 4C, the user computer 20 corresponds to a mobile device 415, using, for example, an app that is specific to the publisher system 10 to interact with the interface (not shown), in order to view the supplemental content 422 corresponding to the transaction listing from the system 100. In FIG. 4B, while the supplemental content 422 is enlarged, it is provided in the framework and branding of the publisher system 10.

FIG. 4D illustrates a variation in which the publisher system 10 enables a functional page module 430 as part of the interface 410. The functional page module may provide alternative forms of content, such as video, text and other rich content specific to a transaction listing that is active and hosted at the system 100.

Computer System

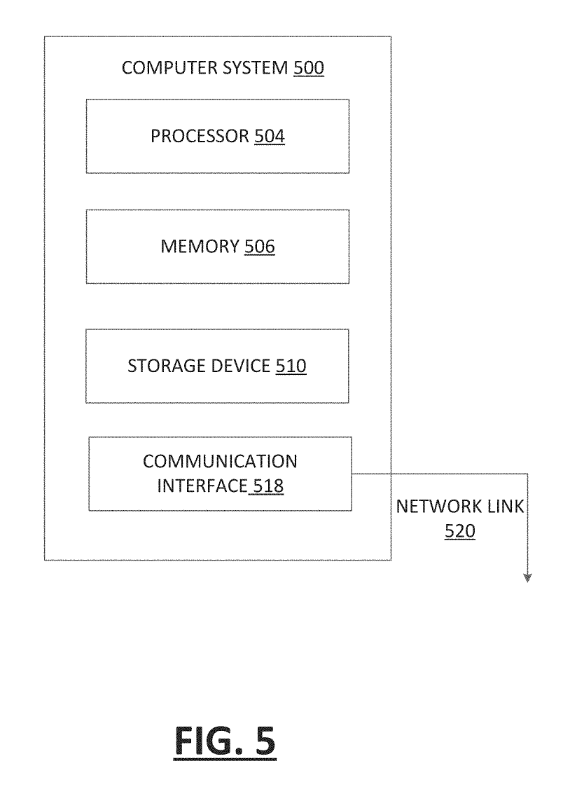

FIG. 5 is a block diagram that illustrates a computer system upon which embodiments described herein may be implemented. For example, in the context of FIG. 1, system 100 may be implemented using one or more servers such as described by FIG. 5. Likewise, a method such as described with FIG. 2 can be implemented using, for example, a computer system such as described with FIG. 5.

In an embodiment, computer system 500 includes processor 504, memory 506 (including non-transitory memory), storage device 510, and communication interface 518. Computer system 500 includes at least one processor 504 for processing information. Computer system 500 also includes the main memory 506, such as a random access memory (RAM) or other dynamic storage device, for storing information and instructions to be executed by processor 504. The memory 506 also may be used for storing temporary variables or other intermediate information during execution of instructions to be executed by processor 504. The memory 506 may also include a read only memory (ROM) or other static storage device for storing static information and instructions for processor 504. The storage device 510, such as a magnetic disk or optical disk, is provided for storing information and instructions. The communication interface 518 may enable the computer system 500 to communicate with one or more networks through use of the network link 520 and any one of a number of well-known transfer protocols (e.g., Hypertext Transfer Protocol (HTTP)). Examples of networks include a local area network (LAN), a wide area network (WAN), the Internet, mobile telephone networks, Plain Old Telephone Service (POTS) networks, and wireless data networks (e.g., WiFi and WiMax networks).

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. As such, many modifications and variations will be apparent to practitioners. Accordingly, it is contemplated that a particular feature described either individually or as part of an example can be combined with other individually described features, or parts of other examples, even if the other features and examples make no mentioned of the particular feature.

What is claimed is:

1. A method for targeting content on the Internet, the method being implemented by one or more processors of a content providing entity and comprising:
controlling, use of a cookie that is placed on individual visitor computers to a resource of a publisher domain, including programmatically causing cookie data determined through placement of the cookie on the individual visitor computers to be directly transmitted to a network location of the content providing entity;
selecting a content item for individual visitor computers of the publisher domain using the cookie data; and
transmitting one or more of the selected content items to the individual visitor computers.

2. The method of claim 1, wherein controlling use of the cookie includes associating the cookie with code that executes on a web page of the publisher domain to transmit the cookie data to the network location of the content providing entity.

3. The method of claim 2, wherein the network location is provided in a network domain that is external to the publisher domain.

4. The method of claim 1, wherein controlling the cookie includes programmatically precluding the cookie data from being received or stored outside of a domain of the content providing entity.

5. The method of claim 1, wherein selecting the content item for individual visitor computers of the publisher domain includes (i) developing a profile for individual visitor computers, and (ii) selecting visitor computers to receive a particular set of content items based at least in part on a first selection criterion.

6. The method of claim 1, wherein controlling use of the cookie includes receiving cookie data at the network location for a visitor computer when the publisher domain displays, for the visitor computer, content for a transaction listing that is active and conducted through a website of the content providing entity.

7. The method of claim 1, wherein controlling use of the cookie includes controlling use of the cookie on multiple publisher domains.

8. The method of claim 1, further comprising:
linking the visitor computer to a user profile using the cookie data, and developing the user profile using the cookie data.

9. The method of claim 8, wherein selecting the content item for individual visitor computers includes selecting the content item for individual visitor computers using the linked user profile for the individual visitor computers.

10. The method of claim 1, wherein selecting the content item for individual visitor computers includes analyzing the cookie data of the individual visitor computers to develop a profile for each visitor computer.

11. The method of claim 1, wherein selecting the content item for individual visitor computers includes selecting a set of at least one content items for a group of individual visitor computers.

12. The method of claim 11, wherein selecting the content items as part of a campaign that is defined by the content providing entity.

13. The method of claim 12, wherein selecting the content item for individual visitor computers includes selecting a set of at least one content items for each of the visiting computers independent of a campaign.

14. The method of claim 1, wherein each content item corresponds to a transaction listing for a non-fungible item.

15. The method of claim 1, wherein each content item corresponds to a transaction listing for a real-estate listing.

16. The method of claim 1, wherein each content item corresponds to a transaction listing for a non-fungible item, the transaction listing being selected from an inventory of transaction listings which are active at a domain of the content providing entity.

17. The method of claim 1, further comprising:
receiving cookie data that identifies one or more characteristics of a non-fungible asset of a transaction listing, wherein information about the non-fungible asset is rendered to the visitor computer as part of the resource of the publisher domain.

18. The method of claim 17, wherein the transaction listing is active on a site hosted by the content providing entity.

19. The method of claim 17, wherein the non-fungible asset corresponds to a real-estate asset, and wherein the one or more characteristics corresponds to a geographic parameter indicating one of a state, city or neighborhood of the real-estate listing.

20. The method of claim 17, wherein the non-fungible asset corresponds to a real-estate asset, and wherein the one or more characteristics corresponds to a parameter for size, condition, price or use of the real-estate asset.
